(19) United States
(12) Patent Application Publication
(10) Pub. No.: US 2026/0237118 A1
(43) Pub. Date: Aug. 13, 2026

(54) IMAGE PROCESSING METHOD AND APPARATUS, AND COMPUTER DEVICE AND STORAGE MEDIUM

(71) Applicant: Beijing Zitiao Network Technology Co., Ltd., Beijing (CN)

(72) Inventor: Yuanlue ZHU, Beijing (CN)

(21) Appl. No.: 19/156,394

(22) PCT Filed: Feb. 7, 2024
(86) PCT No.: PCT/CN2024/076570

§ 371 Date: Aug. 13, 2025

(30) Foreign Application Priority Data
Feb. 15, 2023 (CN) 202310171738.3

(51) Int. Cl. G06T 11/60; G06T 3/40; G06T 5/50; G06V 10/25; G06V 10/764

(52) U.S. Cl. CPC G06T 11/60; G06T 3/40; G06T 5/50; G06V 10/25; G06V 10/764; G06T 2207/20221; G06T 2207/30196

(57) ABSTRACT

An image processing method and an apparatus, a computer device, and a storage medium are provided. The method includes: obtaining an image to be processed; determining an adjustment coefficient for the image to be processed, wherein the adjustment coefficient is configured to represent an adjustment degree of a presentation state of a hair part of the image to be processed; and adjusting the presentation state of the hair part of the image to be processed based on the adjustment coefficient and a state adjustment model to generate a target image.

This application claims priority to Chinese Patent Application No. 202310171738.3 filed on Feb. 15, 2023, the entire disclosure of which is incorporated herein by reference as part of the present disclosure.

### TECHNICAL FIELD

The present disclosure relates to an image processing method and an apparatus, a device, and a storage medium.

### BACKGROUND

With the development of the technology, electronic devices have become essential articles in people's life. An electronic device, such as a mobile phone, a tablet computer, and a camera, has the image pick-up function, and thus can be used by a user to take a picture, thereby achieving image pick-up.

The electronic device can be used to take a picture of the user to obtain a user image. When the user image includes the hair part of the user, since the hair of the user may be frizzy and dull, the presentation effect of the hair region in the user image may be poor.

### SUMMARY

Embodiments of the present disclosure at least provide an image processing method and an apparatus, a device, and a storage medium.

On the first aspect, the embodiments of the present disclosure provide an image processing method, comprising: obtaining an image to be processed; determining an adjustment coefficient for the image to be processed, wherein the adjustment coefficient is configured to represent an adjustment degree of a presentation state of a hair part of the image to be processed; and adjusting the presentation state of the hair part of the image to be processed based on the adjustment coefficient and a state adjustment model to generate a target image.

In an optional implementation, the determining an adjustment coefficient for the image to be processed comprises: receiving an initial coefficient input by a user, and determining the initial coefficient as the adjustment coefficient for the image to be processed; or, detecting the presentation state of the hair part of the image to be processed with a trained target classifier to obtain a detection result of the image to be processed; and determining the adjustment coefficient for the image to be processed according to the detection result of the image to be processed.

In an optional implementation, the adjusting the presentation state of the hair part of the image to be processed based on the adjustment coefficient and a state adjustment model to generate a target image comprises: determining, in the image to be processed, a first region image where the hair part of the image to be processed is located; adjusting, by using the state adjustment model, the presentation state of the hair part of the image to be processed in the first region image based on the adjustment coefficient to generate a second region image; and replacing the first region image in the image to be processed with the second region image to generate the target image.

In an optional implementation, the adjusting, by using the state adjustment model, the presentation state of the hair part of the image to be processed in the first region image based on the adjustment coefficient to generate a second region image comprises: adjusting a size of the first region image to a preset size, and generating a single-channel image of the preset size based on the adjustment coefficient; performing channel cascading on the adjusted first region image and the single-channel image to generate a cascaded image; and inputting the cascaded image to the state adjustment model to generate the second region image.

In an optional implementation, obtaining the state adjustment model comprises: obtaining a data set, wherein the data set comprises a plurality of image pairs; each image pair comprises a first image and a second image matching the first image, and the second image is generated by adjusting a hair part of the first image; generating a reconstructed image corresponding to the first image based on a preset adjustment coefficient, the first image of the image pair, and a state adjustment model to be trained, and determining a target loss based on the second image of the image pair and the reconstructed image; and adjusting a network parameter of the state adjustment model using the target loss of at least one image pair to obtain an updated state adjustment model.

In an optional implementation, the obtaining a data set comprises: obtaining a plurality of original images; adjusting a hair part of each of the plurality of original images to generate a tagged image matching the original image; preprocessing the original image and the tagged image matching the original image respectively to generate a processed original image and a processed tagged image; and using the processed original image as the first image and the processed tagged image as the second image to form an image pair, a plurality of image pairs constituting the data set.

In an optional implementation, the adjusting a hair part of each original image to generate a tagged image matching the original image comprises: for each original image, adjusting a first presentation state of the hair part of the original image to generate an intermediate image in response to a triggered tagging operation; detecting the intermediate image to determine a region where the hair part of the original image is located in the intermediate image; determining target filter information based on pixel information of the region where the hair part of the original image is located in the intermediate image; and adjusting a second presentation state of the hair part of the intermediate image based on the target filter information to obtain the tagged image matching the original image.

In an optional implementation, the determining target filter information based on pixel information of the region where the hair part of the original image is located in the intermediate image comprises: determining an average pixel value of the hair part of the intermediate image based on the pixel information of the region where the hair part of the original image is located in the intermediate image; and determining the target filter information based on the average pixel value and a preset pixel value.

In an optional implementation, preprocessing the original image to generate the processed original image comprises: determining hair region information in the original image; generating adjusted hair region information according to the hair region information in the original image and a zoom-in ratio; obtaining a hair region image from the original image based on the adjusted hair region information and a cropping ratio; and performing target processing on the hair region image to generate the processed original image, wherein the target processing comprises at least one selected from the group consisting of rotation, flipping, and size adjustment.

In an optional implementation, generating a reconstructed image corresponding to the first image based on a preset adjustment coefficient, the first image of the image pair, and a state adjustment model to be trained comprises: generating a first reconstructed image corresponding to the first image based on a first preset adjustment coefficient, the first image of the image pair, and the state adjustment model to be trained; and generating a second reconstructed image corresponding to the first image based on a second preset adjustment coefficient, the first image of the image pair, and the state adjustment model to be trained, wherein the second preset adjustment coefficient is greater than the first preset adjustment coefficient; and the determining a target loss based on the second image of the image pair and the reconstructed image comprises: generating the target loss based on the first image and the second image of the image pair, the first reconstructed image, and the second reconstructed image.

In an optional implementation, the generating the target loss based on the first image and the second image of the image pair, the first reconstructed image, and the second reconstructed image comprises: generating a reconstruction loss based on the second reconstructed image and the second image, wherein the reconstruction loss represents a deviation degree between the second reconstructed image and the second image; generating a self-reconstruction loss based on the first reconstructed image and the first image, wherein the self-reconstruction loss represents a deviation degree between the first reconstructed image and the first image; and determining the target loss based on the reconstruction loss and the self-reconstruction loss.

On the second aspect, the embodiments of the present disclosure further provide an image processing apparatus, comprising: an obtaining module configured to obtain an image to be processed; a determination module configured to determine an adjustment coefficient for the image to be processed, wherein the adjustment coefficient is configured to represent an adjustment degree of a presentation state of a hair part of the image to be processed; and an adjustment module configured to adjust the presentation state of the hair part of the image to be processed based on the adjustment coefficient and a state adjustment model to generate a target image.

In an optional implementation, the determination module, when determining the adjustment coefficient for the image to be processed, is configured to receive an initial coefficient input by a user, and determine the initial coefficient as the adjustment coefficient for the image to be processed; or, detect the presentation state of the hair part of the image to be processed with a trained target classifier to obtain a detection result of the image to be processed; and determine the adjustment coefficient for the image to be processed according to the detection result of the image to be processed.

In an optional implementation, the determination module, when adjusting the presentation state of the hair part of the image to be processed based on the adjustment coefficient and a state adjustment model to generate a target image, is configured to determine, in the image to be processed, a first region image where the hair part of the image to be processed is located; adjust, by using the state adjustment model, the presentation state of the hair part of the image to be processed in the first region image based on the adjustment coefficient to generate a second region image; and replace the first region image in the image to be processed with the second region image to generate the target image.

In an optional implementation, the determination module, when adjusting, by using the state adjustment model, the presentation state of the hair part of the image to be processed in the first region image based on the adjustment coefficient to generate a second region image, is configured to adjust a size of the first region image to a preset size, and generate a single-channel image of the preset size based on the adjustment coefficient; perform channel cascading on the adjusted first region image and the single-channel image to generate a cascaded image; and input the cascaded image to the state adjustment model to generate the second region image.

In an optional implementation, the apparatus further includes a training module which is configured to obtain the state adjustment model through the following steps: obtaining a data set, wherein the data set comprises a plurality of image pairs; each image pair comprises a first image and a second image matching the first image, and the second image is generated by adjusting a hair part of the first image; generating a reconstructed image corresponding to the first image based on a preset adjustment coefficient, the first image of the image pair, and a state adjustment model to be trained, and determining a target loss based on the second image of the image pair and the reconstructed image; and adjusting a network parameter of the state adjustment model using the target loss of at least one image pair to obtain an updated state adjustment model.

In an optional implementation, the training module, when obtaining the data set, is configured to obtain a plurality of original images; adjust a hair part of each of the plurality of original images to generate a tagged image matching the original image; preprocess the original image and the tagged image matching the original image respectively to generate a processed original image and a processed tagged image; and use the processed original image as the first image and the processed tagged image as the second image to form an image pair, a plurality of image pairs constituting the data set.

In an optional implementation, the training module, when adjusting the hair part of each original image to generate a tagged image matching the original image, is configured to: for each original image, adjust a first presentation state of the hair part of the original image to generate an intermediate image in response to a triggered tagging operation; detect the intermediate image to determine a region where the hair part of the original image is located in the intermediate image; determine target filter information based on pixel information of the region where the hair part of the original image is located in the intermediate image; and adjust a second presentation state of the hair part of the intermediate image based on the target filter information to obtain the tagged image matching the original image.

In an optional implementation, the training module, when determining target filter information based on pixel information of the region where the hair part of the original image is located in the intermediate image, is configured to determine an average pixel value of the hair part of the intermediate image based on the pixel information of the region where the hair part of the original image is located in the intermediate image; and determine the target filter information based on the average pixel value and a preset pixel value.

In an optional implementation, the training module, when preprocessing the original image to generate the processed original image comprises, is configured to determine hair region information in the original image; generate adjusted hair region information according to the hair region information in the original image and a zoom-in ratio; obtain a hair region image from the original image based on the adjusted hair region information and a cropping ratio; and perform target processing on the hair region image to generate the processed original image, wherein the target processing comprises at least one selected from the group consisting of rotation, flipping, and size adjustment.

In an optional implementation, the training module, when generating the reconstructed image corresponding to the first image based on the preset adjustment coefficient, the first image of the image pair, and a state adjustment model to be trained, is configured to generate a first reconstructed image corresponding to the first image based on a first preset adjustment coefficient, the first image of the image pair, and the state adjustment model to be trained; and generate a second reconstructed image corresponding to the first image based on a second preset adjustment coefficient, the first image of the image pair, and the state adjustment model to be trained, wherein the second preset adjustment coefficient is greater than the first preset adjustment coefficient. The training module, when determining a target loss based on the second image of the image pair and the reconstructed image, is configured to generate the target loss based on the first image and the second image of the image pair, the first reconstructed image, and the second reconstructed image.

In an optional implementation, the training module, when generating the target loss based on the first image and the second image of the image pair, the first reconstructed image, and the second reconstructed image, is configured to generate are construction loss based on the second reconstructed image and the second image, wherein the reconstruction loss represents a deviation degree between the second reconstructed image and the second image; generate a self-reconstruction loss based on the first reconstructed image and the first image, wherein the self-reconstruction loss represents a deviation degree between the first reconstructed image and the first image; and determine the target loss based on the reconstruction loss and the self-reconstruction loss.

On the third aspect, the embodiments of the present disclosure further provide a computer device, comprising a processor, a memory and a bus, wherein the memory stores machine-readable instructions executable by the processor; when the computer device runs, the processor communicates with the memory through the bus; and when the machine-readable instructions are executed by the processor, the image processing method according to the first aspect or any one optional implementation of the first aspect.

On the fourth aspect, the embodiments of the present disclosure further provide a computer-readable storage medium, storing a computer program which, when run by a processor, performs the image processing method according to the first aspect or any one optional implementation of the first aspect.

In order to make the above objectives, features, and advantages of the present disclosure more understandable, the present disclosure is described in detail below using preferred embodiments with reference to the accompanying drawings.

### BRIEF DESCRIPTION OF DRAWINGS

In order to illustrate the technical solutions of the embodiments of the present disclosure more clearly, the accompanying drawings needing to be used in the embodiments will be briefly described below. The accompanying drawings incorporated into and constituting part of the specification illustrate the embodiments of the present disclosure, and serve, together with the specification, to illustrate the technical solutions of the present disclosure. It should be understood that the following figures show merely some embodiments of the present disclosure, and thus should not be regarded as a limitation to the scope. A person of ordinary skill in the art may still derive other related figures from these figures without creative efforts.

FIG. 1 illustrates a flowchart of an image processing method provided by an embodiment of the present disclosure;

FIG. 2 illustrates a flowchart of a specific process of training a state adjustment model in an image processing method provided by an embodiment of the present disclosure;

FIG. 3 illustrates a schematic diagram of an image processing apparatus provided by an embodiment of the present disclosure; and

FIG. 4 illustrates a structural schematic diagram of a computer device provided by an embodiment of the present disclosure.

### DETAILED DESCRIPTION

In order to make the objectives, technical solutions, and advantages of the embodiments of the present disclosure clearer, the technical solutions in the embodiments of the present disclosure are clearly and completely described below with reference to the drawings in the embodiments of the present disclosure. Apparently, the described embodiments are merely a part rather than all of the embodiments of the present disclosure. Generally, the components of the embodiments of the present disclosure described and shown in the drawings may be arranged and designed in various manners. Therefore, the detailed description of the embodiments of the present disclosure with reference to the accompanying drawings is not intended to limit the protection scope of the present disclosure, but merely to represent the selected embodiments of the present disclosure. All other embodiments derived from the embodiments of the present disclosure by those of ordinary skill in the art without creative efforts shall fall within the protection scope of the present disclosure.

In a physical scene, an electronic device can be used to take a picture of a user to obtain a user image. When the user image includes the hair part of the user, since the hair of the user may be frizzy and dull, the presentation effect of the hair region in the user image may be poor. Thus, beautifying the hair region in the user image has become one of the basic requirements of the user.

For example, after a user image is obtained, the user can adjust the hair using a beauty tool. However, the manual adjustment manner has the problem that the image adjustment process is tedious such that the image processing efficiency is low.

Based on the above-mentioned study, the present disclosure provides an image processing method. After an image to be processed is obtained, an adjustment coefficient for the image to be processed is determined, and a presentation state (which may be, for example, a soft state, a glossy state, or the like) of a hair part of the image to be processed is adjusted based on the adjustment coefficient and a trained state adjustment model to generate a target image such that the soft state and the glossy state of the hair part of the target image are better. The presentation effect of the target image is improved. In this solution, with the state adjustment model, the processing of the hair part of the image to be processed can be realized more intelligently on the basis of guaranteeing the presentation effect of the target image, and the image processing effect and efficiency are improved. Meanwhile, since the adjustment coefficient can be used for representing an adjustment degree of the presentation state of the hair part of the image to be processed, the adjustment degree of the presentation state of the hair part can be controlled based on the adjustment coefficient to realize flexible adjustment on the hair part. The flexibility of image processing is improved.

It should be noted that similar reference signs and letters represent similar items in the drawings below. Therefore, once an item is defined in one drawing, it does not need to be further defined and described in subsequent drawings.

The term “and/or” used herein merely describes an association relationship, and indicates that three types of relationships may exist. For example, A and/or B may indicate that A exists alone, A and B coexist, or B exists alone. In addition, the term “at least one” used herein represents any one of a plurality of things or any combination of at least two of a plurality of things. For example, at least one of A, B, C may represent any one or more elements selected from a set constituted by A, B, and C.

It will be understood that before using the technical solutions disclosed in various embodiments of the present disclosure, a user should be notified of a type, a range of use, a usage scenario, etc. of personal information involved in the present disclosure in an appropriate manner in accordance with relevant laws and regulations, and these should be authorized by the user.

For example, in response to receiving an active request from a user, a prompt message is sent to the user to explicitly prompt the user that the operation the user requests to perform will require to acquire and use the personal information of the user. Thus, the use can independently select, according to the prompt message, whether or not to provide the personal information to software or hardware such as an electronic device, an application, a server or a storage medium that performs the operations of the technical solutions of the present disclosure.

As an alternative but non-limiting implementation, in response to receiving an active request from a user, a manner of sending a prompt message to the user may be, for example, using a pop-up window in which the prompt message may be presented in the form of text. Furthermore, the pop-up window may also carry option controls for a user to select to “agree” or “disagree” with providing personal information to an electronic device.

It will be understood that the processes of notifying of and authorizing by a user described above are merely exemplary and do not constitute a limitation on the implementations of the present disclosure, and other manners meeting relevant laws and regulations may also be applied to the implementations of the present disclosure.

In order to facilitate the understanding of the embodiments of the present disclosure, firstly, an image processing method disclosed by an embodiment of the present disclosure is introduced in detail. An execution body for the image processing method provided by the embodiment of the present disclosure is generally a computer device having a certain computing power. The computer device may include, for example, a terminal device or a server or other processing device. The terminal device may be a user equipment (UE), a mobile device, a user terminal, a terminal, a personal digital assistant (PDA), a hand-held device, a computing device, a wearable device, and the like. In some possible implementations, the image processing method may be implemented by a processor calling computer-readable instructions stored on a memory.

The image processing method provided by the embodiment of the present disclosure is illustrated below by taking for example that the execution body is the terminal device.

With reference to FIG. 1, there is shown a flowchart of an image processing method provided by an embodiment of the present disclosure. The image processing method includes S101 to S103.

S101, an image to be processed is obtained.

S102, an adjustment coefficient for the image to be processed is determined, wherein the adjustment coefficient is configured to represent an adjustment degree of a presentation state of a hair part of the image to be processed.

S103, the presentation state of the hair part of the image to be processed is adjusted based on the adjustment coefficient and a state adjustment model to generate a target image.

S101 to S103 are described in detail below.

For S101 and S102:

The image to be processed may be an image including hair, e.g., an image including a user's hair or an image including an animal's hair, wherein the image to be processed may be a three-channel image in a red, green, blue (RGB) format. After the image to be processed is obtained, the adjustment coefficient for the image to be processed may be determined. For example, a preset value (e.g., 0.5 or 1) may be determined as the adjustment coefficient for the image to be processed; or, an example image, and adjusted example images obtained by adjusting the example image based on different values may be presented on a display screen so that the user can input a target value in an input interface according to the presented example image and the adjusted example images under different values. The target value input by the user is determined as the adjustment coefficient for the image to be processed.

The adjustment coefficient is configured to represent the adjustment degree of the presentation state of the hair part of the image to be processed, wherein the adjustment coefficient is positively related to the adjustment degree. That is, the greater the adjustment coefficient, the greater the adjustment intensity of the hair part of the image to be processed. Here, the presentation state is capable of representing a presentation effect of the hair part. For example, the presentation state may include a soft state, a glossy state, etc. Generally, the softer the hair, the better the presentation effect of the hair part. When the hair is glossy, and the presentation effect of the hair part is good.

In an optional implementation, determining the adjustment coefficient for the image to be processed comprises:

In manner 1, receiving an initial coefficient input by a user, and determining the initial coefficient as the adjustment coefficient for the image to be processed.

In manner 2, detecting the presentation state of the hair part of the image to be processed with a trained target classifier to obtain a detection result of the image to be processed, and determining the adjustment coefficient for the image to be processed according to the detection result of the image to be processed.

In the manner 1, in the implementation, an operation interface may be displayed on the display screen so that the user can input the initial coefficient in the operation interface. The initial coefficient input by the user is received, and the initial coefficient is determined as the adjustment coefficient for the image to be processed. A numerical range may also be presented in the operation interface so that the initial coefficient input by the user is within the numerical range.

Exemplarily, in order to enable the user to accurately determine the desired adjustment coefficient, an example image, and adjusted example images obtained by adjusting the example image with a plurality of values may be presented on the display screen. For example, if the numerical range is 0-5, the example image, the adjusted example image obtained when the value is 0, the adjusted example image when the value is 1, the adjusted example image obtained when the value is 5, and the like may be presented so that the user can know the adjustment effects under different values intuitively and clearly and thus can determine the desired initial coefficient accurately.

In the manner 2, in the implementation, the target classifier can be trained, wherein a network result of the target classifier may be set as required. For example, the target classifier may be a neural network composed of a convolutional layer, a fully connected layer, an activation function, and the like. The image to be processed is input to the target classifier. The target classifier detects the presentation state of the hair part of the image to be processed to obtain the detection result of the image to be processed. For example, the detection result of the image to be processed may be 0 (excellent hair state), 1 (good hair state), 2 (poor hair state), 3 (bad hair state), or the like; or, the detection result of the image to be processed may be 0 (state 0), 1 (state 1), 2 (state 2), . . . , n (state n), or the like, n being a positive integer.

The adjustment coefficient for the image to be processed is then determined according to the detection result of the image to be processed. Exemplarily, a mapping relationship between a hair state and an adjustment coefficient may be set, and the adjustment coefficient for the image to be processed may be then determined according to the mapping relationship and the detection result. For example, the mapping relationship may be as follows: the adjustment coefficient is 0.5 at 0 (excellent hair state), the adjustment coefficient is 1 at 1 (good hair state), the adjustment coefficient is 2 at 2 (poor hair state), the adjustment coefficient is 5 at 3 (bad hair state), etc. When the detection result is 2, the adjustment coefficient for the image to be processed is 2.

Exemplarily, the target classifier may be trained according to the steps of: obtaining a plurality of training images, wherein each training image carries a tagging label which is configured to represent a presentation state of the user hair part of the training image; inputting the training image to an initial neural network to generate a predicted label of the training images; then determining a loss value according to the tagging label and the predicted label; adjusting a network parameter of the initial neural network according to the loss value to obtain an adjusted neural network, thereby completing network training once; performing a plurality of the training processes until the resulting adjusted neural network meets a training termination condition; and determining the adjusted neural network obtained by the last training as the target classifier. For example, the training termination condition may include: the loss value of the adjusted neural network being less than a preset value, or a number of times of training being greater than a preset number, or the adjusted neural network converges, etc.

Here, by setting a plurality of manners, the adjustment coefficient for the image to be processed may be determined flexibly. For example, the adjustment coefficient for the image to be processed may be determined simply and rapidly in the manner 1. In the manner 2, the detection result of the image to be processed is obtained by detecting the presentation state of the hair part of the image to be processed using the target classifier, and then the adjustment coefficient for the image to be processed is determined according to the detection result. In this way, the adjustment coefficient can be enabled to well match the image to be processed. That is, the target image with good presentation effect can be generated when the image to be processed is subsequently processed with the adjustment coefficient.

For S103:

In the implementation, the adjustment coefficient and the image to be processed can be input to the state adjustment model, and the state adjustment model adjusts the presentation state of the hair part of the image to be processed according to the adjustment coefficient to generate the target image. A model structure of the state adjustment model may be set as required. For example, the state adjustment model may be an adversarial neural network, such as a pix2pix network. For example, the pix2pix network can reconstruct the image to be processed according to the adjustment coefficient to generate the target image. The presentation state of the hair part of the target image is superior to the hair part of the image to be processed. For example, a softness degree of the hair part of the target image is superior to that of the image to be processed, and other region image than the hair part of the target image is identical to the image to be processed.

In optional implementation, the adjusting the presentation state of the hair part of the image to be processed based on the adjustment coefficient and a state adjustment model to generate a target image includes:
step a1, determining, in the image to be processed, a first region image where the hair part is located;
step a2, adjusting, by using the state adjustment model, the presentation state of the hair part of the first region image based on the adjustment coefficient to generate a second region image; and
step a3, replacing the first region image in the image to be processed with the second region image to generate the target image.

In step a1, the image to be processed may be segmented to generate a segmented image; and the first region image where the hair part is located is determined in the image to be processed according to the position information of the hair part indicated by the segmented image. Alternatively, after the segmented image is generated, the region information of the region where the hair part of the image to be processed is located is determined according to the segmented image. For example, the region information may be center point position information, a width w, and a height h, etc. of the region where the hair part is located. The region information of the region where the hair part is located is then adjusted based on a set zoom-in ratio to generate adjusted region information. For example, when the zoom-in ratio is 1.1, the adjusted region information may be the center point position information (not changing), the width 1.1 w, or the height 1.1 h. The first region image where the hair part is located may be then determined from the image to be processed according to the adjusted region information.

In step a2, the presentation state of the hair part of the first region image is adjusted by using the state adjustment model based on the adjustment coefficient to generate the second region image. Here, the first region image is input to the state adjustment model for processing. Compared with using the image to be processed as an input, the throughput of the model can be reduced, and the processing efficiency of the model can be improved; meanwhile, the interference of other regions than the hair part can be relieved, and the processing accuracy of the model can be improved.

In an optional implementation, in step a2, the adjusting, by using the state adjustment model, the presentation state of the hair part of the image to be processed in the first region image based on the adjustment coefficient to generate a second region image includes:
step a21, adjusting a size of the region image to a preset size, and generating a single-channel image of the preset size based on the adjustment coefficient;
step a22, performing channel cascading on the adjusted region image and the single-channel image to generate a cascaded image; and
step a23, inputting the cascaded image to the state adjustment model to generate the second region image.

Since the state adjustment model has a requirement on a size of input data, the size of the region image can be adjusted to the preset size first. The preset size is the size of the input data required by the state adjustment model. The single-channel image of the preset size is generated based on the adjustment coefficient. A pixel value of each pixel in the single-channel image is the adjustment coefficient. For example, when the adjustment coefficient is 1, the pixel values of the pixels in the single-channel image are all 1.

Channel cascading is then performed on the adjusted region image and the single-channel image to generate the cascaded image. For example, if the adjusted region image is an image of height H×width W×3 channels, the generated cascaded image is an image of H×W×(3+1), The cascaded image is then input to the state adjustment model to generate the second region image. Compared with the first region image, the second region image is an image after the presentation state of the hair part is adjusted.

Here, the single-channel image is generated according to the adjustment coefficient, and channel cascading is performed on the adjusted region image and the single-channel image to generate the cascaded image. The cascaded image is input to the trained state adjustment model to generate the second region image. The control of the adjustment degree of the presentation state of the hair part is realized with the adjustment coefficient so that the second region image can be generated accurately and flexibly.

In step a3, after the second region image is generated, the first region image in the image to be processed may be replaced with the second region image to generate the target image.

The specific process of obtaining the state adjustment model is described below.

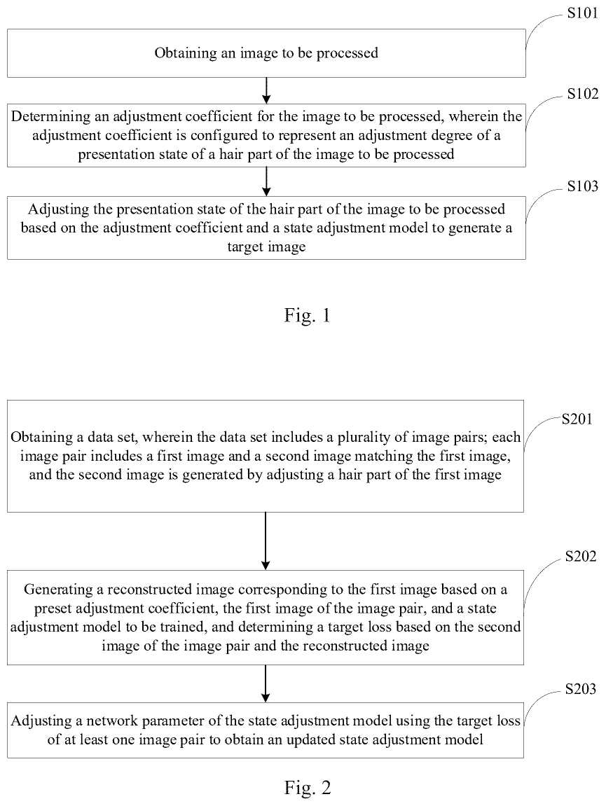

In an optional implementation, with reference to FIG. 2, the state adjustment model is obtained according to the following steps:

S201, obtaining a data set, wherein the data set includes a plurality of image pairs; each image pair includes a first image and a second image matching the first image, and the second image is generated by adjusting a hair part of the first image;

S202, generating a reconstructed image corresponding to the first image based on a preset adjustment coefficient, the first image of the image pair, and a state adjustment model to be trained, and determining a target loss based on the second image of the image pair and the reconstructed image; and

S203, adjusting a network parameter of the state adjustment model using the target loss of at least one image pair to obtain an updated state adjustment model.

In S201, the data set may include a plurality of image pairs; each image pair includes the first image, and the second image matching the first image, and the second image is generated by adjusting the hair part of the first image. In the implementation, the first image may be obtained by using a search engine, an open source database, or the like, and then the hair part of the first image is adjusted to generate the second image matching the first image.

In an optional implementation, obtaining the data set includes:
step b1, obtaining a plurality of original images;
step b2, adjusting a hair part of each original image to generate a tagged image matching the original image;
step b3, preprocessing the original image and the tagged image matching the original image respectively to generate a processed original image and a processed tagged image; and
step b4, using the processed original image as the first image and the processed tagged image as the second image to form an image pair, and constituting the data set with the plurality of image pairs.

In step b1, the original image may be an unadjusted image. The original image may include a user image of a plurality of sample users, or may be an object image including a sample object such as a cat and a dog.

In step b2, the hair part of each original image may be adjusted. For example, the hair part of each original image may be adjusted in response to a triggered image retouching operation, and other regions than the hair part are not adjusted, thereby generating the tagged image matching the original image.

In an optional implementation, in step b2, the adjusting a hair part of each original image to generate a tagged image matching the original image specifically includes:
step b21, for each original image, in response to a triggered tagging operation, adjusting a first presentation state of the hair part of the original image to generate an intermediate image;
step b22, detecting the intermediate image to determine a region where the hair part is located in the intermediate image;
step b23, determining target filter information based on pixel information of the region where the hair part is located in the intermediate image; and
step b24, adjusting a second presentation state of the hair part of the intermediate image based on the target filter information to obtain the tagged image matching the original image.

In the implementation, for each original image, in the tagging procedure, in response to the triggered tagging operation, the first presentation state of the hair part of the original image is adjusted to generate the intermediate image. The first presentation state may be, for example, the soft state of the hair part.

The intermediate image is detected to generate a hair segmented image. For example, an image segmentation network may be utilized to detect the intermediate image to generate the hair segmented image; and the region where the hair part is located in the intermediate image may be determined according to the segmented image. Alternatively, a contour detection network may be utilized to perform contour detection on the intermediate image to determine the region where the hair part is located in the intermediate image.

The target filter information is then determined according to the pixel information of the region where the hair part is located in the intermediate image. For example, if the pixel information of the region where the hair part is located in the intermediate image indicates that the color of the hair part is a light color, first filter information may be determined as the target filter information. If the pixel information of the region where the hair part is located in the intermediate image indicates that the color of the hair part is a dark color, second filter information may be determined as the target filter information. The first filter information may be light color filter information, and the second filter information may be dark color filter information.

In an optional implementation, the determining target filter information based on pixel information of the region where the hair part is located in the intermediate image includes: determining an average pixel value of the hair part based on the pixel information of the region where the hair part is located in the intermediate image; and determining the target filter information based on the average pixel value and a preset pixel value.

In the implementation, the pixel information of the region where the hair part is located in the intermediate image may be averaged to obtain the average pixel value of the hair part. Considering that the intermediate image may be a multi-channel image, for each channel, the average pixel value of the hair part on the channel may be determined, and then the average pixel values on the channels are averaged to obtain the average pixel value of the hair part.

Exemplarily, the intermediate image is subjected to hair segmentation to generate a hair segmented image. The average pixel value of the hair part may be determined with the hair segmented image and the intermediate image. Since the pixel value of each pixel in the hair segmented image ranges from 0 to 255, the pixel value of each pixel in the hair segmented image may be normalized (e.g., the pixel value of each pixel point is divided by 255) to generate a processed hair segmented image. For each channel, the average pixel value of the hair part on the channel may be calculated according to the following formula (1) based on the processed hair segmented image and the intermediate image:

$$color\_mean = \frac{sum ( img\_y \times ( mask / 255 ) )}{sun ( m a s k / 255 )} \qquad ( 1 )$$

wherein color_mean represents the average pixel value of the hair part on the channel; img_y includes pixel values of the pixels within the channel in the intermediate image; mask represents the hair segmented image before the normalization processing; and mask/255 is the pixel value of each pixel in the processed hair segmented image. For each channel, the pixel values of the pixels at the same pixel position in the intermediate image and the processed hair segmented image are multiplied, and then a plurality of resulting products are added together to obtain a first sum; and the pixel values of the pixels in the processed hair segmented image are added together to obtain a second sum. The first sum is divided by the second sum to obtain the average pixel value of the hair part on the channel. Finally, the average pixel values on a plurality of channels are averaged to obtain the average pixel value of the hair part.

Thus, the target filter information may be determined based on the average pixel value and the preset pixel value. For example, the first filter information and the second filter information may be set. The color of the second filter information is deeper than that of the first filter information. That is, the first filter information may be the light color filter information, and the second filter information may be dark color filter information. If the average pixel value is greater than or equal to the preset pixel value, the first filter information is selected as the target filter information. If the average pixel value is less than the preset pixel value, the second filter information is selected as the target filter information. The preset pixel value, the first filter information, and the second filter information may be determined according to an actual situation.

Here, the average pixel value is determined, which may represent a degree of brightness of the hair part, and then the target filter information can be determined accurately with the average pixel value and the preset pixel value. For example, if the average pixel value indicates high brightness of the hair part, the target filter information may be determined as a light color filter. Conversely, if the average pixel value indicates low brightness of the hair part, the target filter information may be determined as a dark color filter. Thus, a realistic and natural tagged image can be obtained subsequently based on the target filter information. The presentation effect of the tagged image is improved.

After the target filter information is determined, the second presentation state of the hair part of the intermediate image may be adjusted by using an image filter algorithm based on the target filter information to obtain the tagged image matching the original image.

Exemplarily, the tagged image may be generated according to the following formula (2):

$$ing\_z = lut [ ( img\_y ) \times ( mask / 255 ) ] + img\_y \times ( 1 - mask / 255 ) \qquad ( 2 )$$

wherein img_z represents the tagged image; img_y represents the intermediate image; mask represents the hair segmented image before the normalization processing; and lut represents an operation identifier corresponding to the image filter algorithm. That is, the image filter algorithm adds a filter to the hair part of the intermediate image based on the target filter information and add no filter to other regions than the hair part of the intermediate image to obtain the tagged image.

In step b3, the original image and the tagged image matching the original image may be preprocessed separately to generate the processed original image and the processed tagged image, wherein preprocessing may, for example, include size adjustment, cropping, flipping, and the like; and the preprocessing processes of the original image and the tagged image are the same. The following description is made by taking preprocessing the original image as an example.

In an optional implementation, the preprocessing the original image to generate the processed original image includes: determine hair region information in the original image; generating adjusted hair region information according to the hair region information and a zoom-in ratio; obtaining a hair region image from the original image based on the adjusted hair region information and a cropping ratio; and performing target processing on the hair region image to generate the processed original image, wherein the target processing includes at least one selected from the group consisting of rotation, flipping, and size adjustment.

In the implementation, the hair region information in the original image may be determined. For example, when the original image includes a user, hair segmentation may be performed on the original image to determine the hair region information of the user in the original image. For example, the hair region information may be detection box information of the region which the hair is located, including coordinate information of a center point of the detection box, and a width and a height of the detection box. The adjusted hair region information is generated according to the hair region information and the zoom-in ratio. For example, the zoom-in ratio may be 1.5, and the adjusted hair region information may include the coordinate information of the center point, 1.5 times width, and 1.5 times height of the detection box.

In the implementation, a local region matching the adjusted hair region information may be determined from the original image; and the local region may be randomly cropped according to a cropping ratio to obtain one or more hair region images. Alternatively, a plurality of cropping ratios may be set. The local region is randomly cropped according to different cropping ratios to obtain one or more hair region images. For example, according to the cropping ratio 1, the local region is randomly cropped to obtain the hair region image 1; and according to the cropping ratio 2, the local region is randomly cropped to obtain the hair region image 2.

Target processing is then performed on each hair region image to generate the processed original image, wherein the target processing includes, but is not limited to, rotation, flipping, size adjustment, and the like. For example, when the original image includes the hair of the user, rotation refers to rotating the head of the user in the hair region image, and a rotation direction and a rotation angle may be generated randomly. Exemplarily, for the same hair region image, different target processing may be performed to obtain a plurality of different processed original images to increase the number of samples of the data set. For example, the rotation operation may be performed on the hair region image 1 to obtain the processed original image 1; and the flipping operation is performed on the hair region image 1 to obtain the processed original image 2, and so on.

In the implementation, the processing process of the tagged image is the same as that of the matching original image. That is, when each processed original image is obtained, a processed tagged image will be obtained correspondingly. Here, the processing process of the tagged image may, for example, be as follows: 1, hair region information in the tagged image is determined. For example, considering that the original image and the tagged image are the same in other information except the presentation state of the hair part, the hair region information in the original image may be determined as the hair region information in the tagged image; 2, adjusted hair region information corresponding to the tagged image is generated according to the hair region information corresponding to the tagged image and a zoom-in ratio; 3, a hair region image is obtained from the tagged image based on the adjusted hair region information corresponding to the tagged image and a cropping ratio; and target processing is performed on the hair region image of the tagged image to generate the processed tagged image, wherein the target processing includes at least one of rotation, flipping, and size adjustment.

Here, a data enhancement operation of sample data can be realized through the above-mentioned process, in order to obtain many processed original images and processed tagged images. Thus, the subsequently generated data set may include many image pairs.

In step b4, the processed original image is used as the first image and the processed tagged image as the second image to form the image pair, and the data set is constituted with the plurality of image pairs.

In S202, a single-channel image may be generated with the preset adjustment coefficient. Channel cascading is then performed on the single-channel image and the first image of the image pair to obtain a cascaded first image; and then the cascaded first image is input to the state adjustment model to be trained to generate the reconstructed image corresponding to the first image. The target loss is then determined based on the second image of the image pair and the reconstructed image. Exemplarily, an adversarial loss value may be determined by using an adversarial loss function (lsgan loss function). The adversarial loss value is determined as a target loss value. In S203, the network parameter of the state adjustment model to be trained can be adjusted using the target loss of at least one image pair to obtain the updated state adjustment model. The training is repeated for a plurality of times until the resulting updated state adjustment model meets a training termination condition. For example, the training termination condition may be the number of times of training being greater than a number threshold, the target loss being less than a loss threshold, etc.

In an optional implementation, the generating a reconstructed image corresponding to the first image based on a preset adjustment coefficient, the first image of the image pair, and a state adjustment model to be trained includes: generating a first reconstructed image corresponding to the first image based on a first preset adjustment coefficient, the first image of the image pair, and the state adjustment model to be trained; and generating a second reconstructed image corresponding to the first image based on a second preset adjustment coefficient, the first image of the image pair, and the state adjustment model to be trained, wherein the second preset adjustment coefficient is greater than the first preset adjustment coefficient.

Considering that the trained state adjustment model is required to be capable of processing the hair part at different adjustment degrees according to different adjustment coefficients, a plurality of preset adjustment coefficients may be set such that the state adjustment model learns difference information of reconstructed images generated with different preset adjustment coefficients.

In the implementation, the first reconstructed image corresponding to the first image may be generated based on the first preset adjustment coefficient, the first image of the image pair, and the state adjustment model to be trained; and the second reconstructed image corresponding to the first image may be generated based on the second preset adjustment coefficient, the first image, and the state adjustment model to be trained, wherein the second preset adjustment coefficient is greater than the first preset adjustment coefficient. For example, the first preset adjustment coefficient may be 0, and the second preset adjustment coefficient may be 0.5. When the first preset adjustment coefficient is 0, it represents that the state adjustment model does not need to reconstruct the input data. That is, when the first preset adjustment coefficient is 0, a reconstructed image output by the state adjustment model should be consistent with an input image as much as possible.

Then, the target loss may be determined based on the first image and the second image of the image pair, the first reconstructed image, and the second reconstructed image.

In an optional implementation, the generating the target loss based on the first image and the second image of the image pair, the first reconstructed image, and the second reconstructed image includes: generating a reconstruction loss based on the second reconstructed image and the second image, wherein the reconstruction loss represents a deviation degree between the second reconstructed image and the second image; generating a self-reconstruction loss based on the first reconstructed image and the first image, wherein the self-reconstruction loss represents a deviation degree between the first reconstructed image and the first image; and determining the target loss based on the reconstruction loss and the self-reconstruction loss.

In the implementation, the reconstruction loss may be generated based on the second reconstructed image and the second image, wherein the reconstruction loss represents the deviation degree between the second reconstructed image and the second image. The loss function used for determining the reconstruction loss may be selected as required. For example, the reconstruction loss may be determined using an L1 norm loss function or a visual geometry group network (VGG) loss function. The reconstruction loss is set to perform parameter adjustment on the state adjustment model to be trained such that the second reconstructed image generated by the updated state adjustment model is close to the second image.

Moreover, the self-reconstruction loss may be generated based on the first reconstructed image and the first image, wherein the self-reconstruction loss represents the deviation degree between the first reconstructed image and the first image. Here, the first preset adjustment coefficient is set to 0 such that the model learns the image information of the input image before reconstruction. That is, the self-reconstruction loss is set to perform parameter adjustment on the state adjustment model to be trained such that the first reconstructed image generated by the updated state adjustment model is close to the first image. The loss function used for determining the self-reconstruction loss may be selected as required. For example, the self-reconstruction loss may be determined using the L1 norm loss function or the VGG loss function. Exemplarily, a loss value determined using the L1 norm loss function may be determined as the self-reconstruction loss; or a loss value determined using the VGG loss function may also be determined as the self-reconstruction loss; or the loss value determined using the L1 norm loss function and the loss value determined using the VGG loss function may be summated and the resulting sum is determined as the self-reconstruction loss.

Thus, the sum of the reconstruction loss and the self-reconstruction loss may be determined as the target loss. The reconstruction loss and the self-reconstruction loss are set such that the updated state adjustment model can process the presentation state of the hair part of the image to be processed at different adjustment degrees according to different adjustment coefficients. The flexibility of image processing is improved.

Exemplarily, an adversarial loss and a segmentation loss may also be determined based on the second reconstructed image and the second image. That is, the adversarial loss is determined using the adversarial loss function such as the lsgan loss function; and the segmentation loss is determined using a segmentation loss function such as a cross-entropy loss function. The sum of the adversarial loss, the segmentation loss, the reconstruction loss, and the self-reconstruction loss is then determined as the target loss.

It will be appreciated by those skilled in the art that in the cluster management method described above, the order of writing the steps does not mean a strict performing order, which imposes no any limitation on the implementation process. The specific order of performing the steps should be determined by the functions thereof and a possible internal logic.

According to the same inventive concept, an embodiment of the present disclosure further provides an image processing apparatus corresponding to the image processing method. Since the principle of the image processing apparatus in the embodiment of the present disclosure to solve the problem is similar to that of the image processing method described above in the embodiments of the present disclosure. Therefore, for the implementations of the image processing apparatus, references may be made to the implementations of the image processing method, and repetitions may not be described herein.

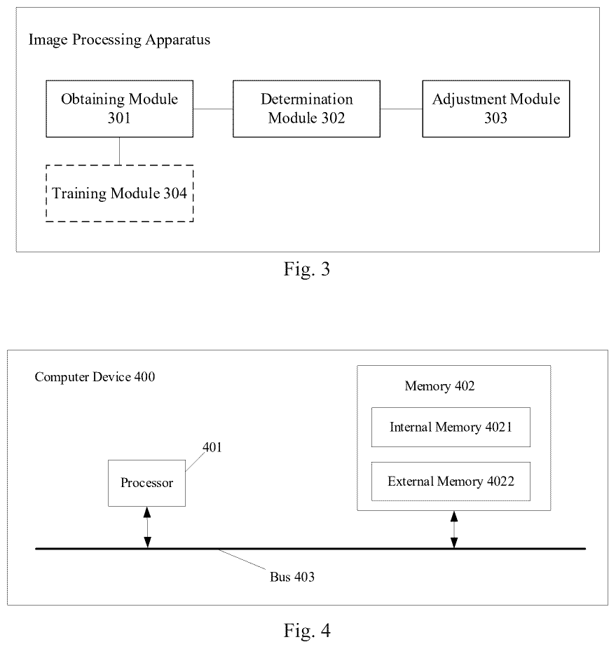

With reference to FIG. 3, there is shown a schematic diagram of an architecture of an image processing apparatus provided by an embodiment of the present disclosure. The image processing apparatus includes an obtaining module 301, a determination module 302, and an adjustment module 303.

The obtaining module 301 is configured to obtain an image to be processed.

The determination module 302 is configured to determine an adjustment coefficient for the image to be processed, wherein the adjustment coefficient is configured to represent an adjustment degree of a presentation state of a hair part of the image to be processed.

The adjustment module 303 is configured to adjust the presentation state of the hair part of the image to be processed based on the adjustment coefficient and a state adjustment model to generate a target image.

In an optional implementation, the determination module 302, when determining the adjustment coefficient for the image to be processed, is configured to: receive an initial coefficient input by a user, and determine the initial coefficient as the adjustment coefficient for the image to be processed; or detect the presentation state of the hair part of the image to be processed with a trained target classifier to obtain a detection result of the image to be processed; and determine the adjustment coefficient for the image to be processed according to the detection result of the image to be processed.

In an optional implementation, the adjustment module 303, when adjusting the presentation state of the hair part of the image to be processed based on the adjustment coefficient and the state adjustment model to generate the target image, is configured to: determine, in the image to be processed, a first region image where the hair part is located; adjust, by using the state adjustment model, the presentation state of the hair part of the first region image based on the adjustment coefficient to generate a second region image; and replace the first region image in the image to be processed with the second region image to generate the target image.

In an optional implementation, the adjustment module 303, when adjusting, by using the state adjustment model, the presentation state of the hair part of the first region image based on the adjustment coefficient to generate the second region image, is configured to: adjust a size of the region image to a preset size, and generate a single-channel image of the preset size based on the adjustment coefficient; perform channel cascading on the adjusted region image and the single-channel image to generate a cascaded image; and input the cascaded image to the state adjustment model to generate the second region image.

In an optional implementation, the image processing apparatus further includes a training module 304 configured to obtain the state adjustment model according to the following steps: obtaining a data set, wherein the data set includes a plurality of image pairs; each image pair includes a first image, and a second image matching the first image, and the second image is generated after adjusting a hair part of the first image; generating a reconstructed image corresponding to the first image based on a preset adjustment coefficient, the first image of the image pair, and a state adjustment model to be trained; determining a target loss based on the second image of the image pair and the reconstructed image; and adjusting a network parameter of the state adjustment model using the target loss of at least one image pair to obtain an updated state adjustment model.

In an optional implementation, the training module 304, when obtaining the data set, is configured to: obtain a plurality of original images; adjust a hair part of each original image to generate a tagged image matching the original image; separately preprocess the original image and the tagged image matching the original image to generate a processed original image and a processed tagged image; and use the processed original image as the first image and the processed tagged image as the second image to form the image pair, and constitute the data set with the plurality image pairs.

In an optional implementation, the training module 304, when adjusting the hair part of each original image to generate the tagged image matching the original image, is configured to: for each original image, in response to a triggered tagging operation, adjust a first presentation state of the hair part of the original image to generate an intermediate image; detect the intermediate image to determine a region where the hair part is located in the intermediate image; determine target filter information based on pixel information of the region where the hair part is located in the intermediate image; and adjust a second presentation state of the hair part of the intermediate image based on the target filter information to obtain the tagged image matching the original image.

In an optional implementation, the training module 304, when determining the target filter information based on the pixel information of the region where the hair part is located in the intermediate image, is configured to: determine an average pixel value of the hair part of the intermediate image based on the pixel information of the region where the hair part is located in the intermediate image; and determine the target filter information based on the average pixel value and a preset pixel value.

In an optional implementation, the training module 304, when preprocessing the original image to generate the processed original image, is configured to: determine hair region information in the original image; generate adjusted hair region information according to the hair region information and a zoom-in ratio; obtain a hair region image from the original image based on the adjusted hair region information and a cropping ratio; and perform target processing on the hair region image to generate the processed original image, wherein the target processing includes at least one selected form the group consisting of rotation, flipping, and size adjustment.

In an optional implementation, the training module 304, when generating the reconstructed image corresponding to the first image based on the preset adjustment coefficient, the first image of the image pair, and the state adjustment model to be trained, is configured to: generate a first reconstructed image corresponding to the first image based on a first preset adjustment coefficient, the first image of the image pair, and the state adjustment model to be trained; and generate a second reconstructed image corresponding to the first image based on a second preset adjustment coefficient, the first image of the image pair, and the state adjustment model to be trained, wherein the second preset adjustment coefficient is greater than the first preset adjustment coefficient. The training module 304, when determining the target loss based on the second image of the image pair and the reconstructed image, is configured to: generate the target loss based on the first image and the second image of the image pair, the first reconstructed image, and the second reconstructed image.

In an optional implementation, the training module 304, when generating the target loss based on the first image and the second image of the image pair, the first reconstructed image, and the second reconstructed image, is configured to: generate a reconstruction loss based on the second reconstructed image and the second image, wherein the reconstruction loss represents a deviation degree between the second reconstructed image and the second image; generate a self-reconstruction loss based on the first reconstructed image and the first image, wherein the self-reconstruction loss represents a deviation degree between the first reconstructed image and the first image; and determine the target loss based on the reconstruction loss and the self-reconstruction loss.

Regarding the descriptions of the processing flow of each module in the apparatus and an interactive flow between the modules, a reference may be made to the related descriptions in the above method embodiments, which will not be described in detail here.

Based on the same technical concept, an embodiment of the present disclosure further provides a computer device. With reference to FIG. 4, there is shown a structural schematic diagram of a computer device 400 provided by an embodiment of the present disclosure, including a processor 401, a memory 402, and a bus 403. The memory 402 is configured to store executable instructions, and includes an internal memory 4021 and an external memory 4022. The internal memory 4021 mentioned here is configured to temporarily store operational data in the processor 401 and data exchanged with the external memory 4022 such as a hard disk. The processor 401 exchanges data with the external memory 4022 through the internal memory 4021. When the computer device 400 runs, the processor 401 is in communication with the memory 402 by the bus 403 such that the processor 401 executes the following instructions: obtaining an image to be processed; determining an adjustment coefficient for the image to be processed, wherein the adjustment coefficient is configured to represent an adjustment degree of a presentation state of a hair part of the image to be processed; and adjusting the presentation state of the hair part of the image to be processed based on the adjustment coefficient and a state adjustment model to generate a target image.

An embodiment of the present disclosure further provides a computer-readable storage medium, storing a computer program which, when run by a processor, performs the steps of the image processing method in the foregoing method embodiments. The storage medium may be a volatile or nonvolatile computer-readable storage medium.

An embodiment of the present disclosure further provides a computer program product, bearing a program code. Instructions included in the program code may be configured to perform the steps of the image processing method in the foregoing method embodiments. Details may be as shown in the foregoing method embodiments and will not be described redundantly here.

The computer program product may be implemented specifically by hardware, software, or a combination thereof. In one optional embodiment, the computer program product is embodied as a computer storage medium. In another optional embodiment, the computer program product is embodied as a software product, e.g., a software development kit (SDK) and the like.

A person skilled in the art can clearly understand that, for convenience and brevity of description, a reference may be made to corresponding processes in the foregoing method embodiments for the specific working process of the system and apparatus described above, which will not be described here redundantly. In several embodiments provided in the present disclosure, it should be understood that the disclosed system, apparatus and method may be implemented in other manners. The apparatus embodiment described above is merely an example. For example, the unit division is merely logical function division and may be other division in actual implementation. For another example, a plurality of units or components may be combined or integrated into another system, or some features may be ignored or not performed. In addition, the displayed or discussed mutual couplings or direct couplings or communication connections may be implemented through some communication interfaces. The indirect couplings or communication connections between the apparatuses or units may be implemented in electrical, mechanical, or other forms.

The units described as separate parts may or may not be physically separate. Parts shown as units may or may not be physical units, which may be located in one position, or may be distributed on a plurality of network units. Some or all of the units may be selected according to actual requirements to achieve the objectives of the solutions of the embodiments.

In addition, functional units in the embodiments of the present disclosure may be integrated into one processing unit, or each of the units may exist alone physically, or two or more units are integrated into one unit.

If implemented in a form of a software functional unit and sold or used as a stand-alone product, functions may be stored in a nonvolatile computer-readable storage medium executable by a processor. Based on such understanding, the technical solutions of the present disclosure essentially, or a part contributing to the prior art, or part of the technical solutions may be implemented in a form of a software product. The computer software product is stored in a storage medium, and includes several instructions for enabling a computer device (which may be a personal computer, a server, a network device, or the like) to perform all or some steps of the method described in the embodiments of the present disclosure. The storage medium includes any medium capable of storing a program code, such as a USB flash disk, a mobile hard disk, a read-only memory (ROM), a random access memory (RAM), a magnetic disk, or an optical disk.

Finally, it should be noted that the above embodiments are merely specific implementations of the present disclosure, and are used to describe rather than limit the technical solutions of the present disclosure. The protection scope of the present disclosure is not limited thereto. Although the present disclosure is described in detail with reference to the above embodiments, it should be understood that a person of ordinary skill in the art can still make modifications to or readily figure out changes in the technical solutions described in the above embodiments, or make equivalent substitutions on some technical features therein. These modifications, changes, or substitutions do not make the essence of the corresponding technical solutions depart from the spirit and scope of the technical solutions of the embodiments of the present disclosure, and shall all fall within the protection scope of the present disclosure. Therefore, the protection scope of the present disclosure shall be subject to the protection scope of the claims.

1. An image processing method, comprising:
obtaining an image to be processed;
determining an adjustment coefficient for the image to be processed, wherein the adjustment coefficient is configured to represent an adjustment degree of a presentation state of a hair part of the image to be processed; and
adjusting the presentation state of the hair part of the image to be processed based on the adjustment coefficient and a state adjustment model to generate a target image.

2. The image processing method according to claim 1, wherein the determining an adjustment coefficient for the image to be processed comprises:
receiving an initial coefficient input by a user, and determining the initial coefficient as the adjustment coefficient for the image to be processed; or
detecting the presentation state of the hair part of the image to be processed with a trained target classifier to obtain a detection result of the image to be processed; and
determining the adjustment coefficient for the image to be processed according to the detection result of the image to be processed.

3. The image processing method according to claim 1, wherein the adjusting the presentation state of the hair part of the image to be processed based on the adjustment coefficient and a state adjustment model to generate a target image comprises:
determining, in the image to be processed, a first region image where the hair part of the image to be processed is located;
adjusting, by using the state adjustment model, the presentation state of the hair part of the image to be processed in the first region image based on the adjustment coefficient to generate a second region image; and
replacing the first region image in the image to be processed with the second region image to generate the target image.

4. The image processing method according to claim 3, wherein the adjusting, by using the state adjustment model, the presentation state of the hair part of the image to be processed in the first region image based on the adjustment coefficient to generate a second region image comprises:
adjusting a size of the first region image to a preset size, and generating a single-channel image of the preset size based on the adjustment coefficient;
performing channel cascading on the adjusted first region image and the single-channel image to generate a cascaded image; and
inputting the cascaded image to the state adjustment model to generate the second region image.

5. The image processing method according to claim 1, wherein obtaining the state adjustment model comprises:
obtaining a data set, wherein the data set comprises a plurality of image pairs; each image pair comprises a first image and a second image matching the first image, and the second image is generated by adjusting a hair part of the first image;
generating a reconstructed image corresponding to the first image based on a preset adjustment coefficient, the first image of the image pair, and a state adjustment model to be trained, and determining a target loss based on the second image of the image pair and the reconstructed image; and
adjusting a network parameter of the state adjustment model using the target loss of at least one image pair to obtain an updated state adjustment model.

6. The image processing method according to claim 5, wherein the obtaining a data set comprises:
obtaining a plurality of original images;
adjusting a hair part of each of the plurality of original images to generate a tagged image matching the original image;
preprocessing the original image and the tagged image matching the original image respectively to generate a processed original image and a processed tagged image; and
using the processed original image as the first image and the processed tagged image as the second image to form an image pair, a plurality of image pairs constituting the data set.

7. The image processing method according to claim 6, wherein the adjusting a hair part of each original image to generate a tagged image matching the original image comprises:
for each original image, adjusting a first presentation state of the hair part of the original image to generate an intermediate image in response to a triggered tagging operation;
detecting the intermediate image to determine a region where the hair part of the original image is located in the intermediate image;
determining target filter information based on pixel information of the region where the hair part of the original image is located in the intermediate image; and
adjusting a second presentation state of the hair part of the intermediate image based on the target filter information to obtain the tagged image matching the original image.

8. The image processing method according to claim 7, wherein the determining target filter information based on pixel information of the region where the hair part of the original image is located in the intermediate image comprises:
determining an average pixel value of the hair part of the intermediate image based on the pixel information of the region where the hair part of the original image is located in the intermediate image; and
determining the target filter information based on the average pixel value and a preset pixel value.

9. The image processing method according to claim 6, wherein preprocessing the original image to generate the processed original image comprises:
determining hair region information in the original image;
generating adjusted hair region information according to the hair region information in the original image and a zoom-in ratio;
obtaining a hair region image from the original image based on the adjusted hair region information and a cropping ratio; and
performing target processing on the hair region image to generate the processed original image, wherein the target processing comprises at least one selected from the group consisting of rotation, flipping, and size adjustment.

10. The image processing method according to claim 5, wherein the generating a reconstructed image corresponding to the first image based on a preset adjustment coefficient, the first image of the image pair, and a state adjustment model to be trained comprises:
generating a first reconstructed image corresponding to the first image based on a first preset adjustment coefficient, the first image of the image pair, and the state adjustment model to be trained; and
generating a second reconstructed image corresponding to the first image based on a second preset adjustment coefficient, the first image of the image pair, and the state adjustment model to be trained, wherein the second preset adjustment coefficient is greater than the first preset adjustment coefficient; and
the determining a target loss based on the second image of the image pair and the reconstructed image comprises:
generating the target loss based on the first image and the second image of the image pair, the first reconstructed image, and the second reconstructed image.

11. The image processing method according to claim 10, wherein the generating the target loss based on the first image and the second image of the image pair, the first reconstructed image, and the second reconstructed image comprises:
generating a reconstruction loss based on the second reconstructed image and the second image, wherein the reconstruction loss represents a deviation degree between the second reconstructed image and the second image;
generating a self-reconstruction loss based on the first reconstructed image and the first image, wherein the self-reconstruction loss represents a deviation degree between the first reconstructed image and the first image; and
determining the target loss based on the reconstruction loss and the self-reconstruction loss.

12. (canceled)

13. A computer device, comprising a processor, a memory and a bus, wherein the memory stores machine-readable instructions executable by the processor; when the computer device runs, the processor communicates with the memory through the bus; and when the machine-readable instructions are executed by the processor, an image processing method is performed, comprising:
obtaining an image to be processed;
determining an adjustment coefficient for the image to be processed, wherein the adjustment coefficient is configured to represent an adjustment degree of a presentation state of a hair part of the image to be processed; and
adjusting the presentation state of the hair part of the image to be processed based on the adjustment coefficient and a state adjustment model to generate a target image.

14. A computer-readable storage medium, storing a computer program which, when run by a processor, performs n image processing method comprising:
obtaining an image to be processed;
determining an adjustment coefficient for the image to be processed, wherein the adjustment coefficient is configured to represent an adjustment degree of a presentation state of a hair part of the image to be processed; and
adjusting the presentation state of the hair part of the image to be processed based on the adjustment coefficient and a state adjustment model to generate a target image.

15. The computer device according to claim 13, wherein the determining an adjustment coefficient for the image to be processed comprises:
receiving an initial coefficient input by a user, and determining the initial coefficient as the adjustment coefficient for the image to be processed; or
detecting the presentation state of the hair part of the image to be processed with a trained target classifier to obtain a detection result of the image to be processed; and
determining the adjustment coefficient for the image to be processed according to the detection result of the image to be processed.

16. The computer device according to claim 13, wherein the adjusting the presentation state of the hair part of the image to be processed based on the adjustment coefficient and a state adjustment model to generate a target image comprises:
determining, in the image to be processed, a first region image where the hair part of the image to be processed is located;
adjusting, by using the state adjustment model, the presentation state of the hair part of the image to be processed in the first region image based on the adjustment coefficient to generate a second region image; and
replacing the first region image in the image to be processed with the second region image to generate the target image.

17. The computer device according to claim 16, wherein the adjusting, by using the state adjustment model, the presentation state of the hair part of the image to be processed in the first region image based on the adjustment coefficient to generate a second region image comprises:
adjusting a size of the first region image to a preset size, and generating a single-channel image of the preset size based on the adjustment coefficient;
performing channel cascading on the adjusted first region image and the single-channel image to generate a cascaded image; and
inputting the cascaded image to the state adjustment model to generate the second region image.

18. The computer device according to claim 13, wherein obtaining the state adjustment model comprises:
obtaining a data set, wherein the data set comprises a plurality of image pairs; each image pair comprises a first image and a second image matching the first image, and the second image is generated by adjusting a hair part of the first image;
generating a reconstructed image corresponding to the first image based on a preset adjustment coefficient, the first image of the image pair, and a state adjustment model to be trained, and determining a target loss based on the second image of the image pair and the reconstructed image; and
adjusting a network parameter of the state adjustment model using the target loss of at least one image pair to obtain an updated state adjustment model.

19. The computer device according to claim 18, wherein the obtaining a data set comprises:
obtaining a plurality of original images;
adjusting a hair part of each of the plurality of original images to generate a tagged image matching the original image;
preprocessing the original image and the tagged image matching the original image respectively to generate a processed original image and a processed tagged image; and
using the processed original image as the first image and the processed tagged image as the second image to form an image pair, a plurality of image pairs constituting the data set.

20. The computer device according to claim 19, wherein the adjusting a hair part of each original image to generate a tagged image matching the original image comprises:
for each original image, adjusting a first presentation state of the hair part of the original image to generate an intermediate image in response to a triggered tagging operation;
detecting the intermediate image to determine a region where the hair part of the original image is located in the intermediate image;
determining target filter information based on pixel information of the region where the hair part of the original image is located in the intermediate image; and
adjusting a second presentation state of the hair part of the intermediate image based on the target filter information to obtain the tagged image matching the original image.

21. The image processing method according to claim 20, wherein the determining target filter information based on pixel information of the region where the hair part of the original image is located in the intermediate image comprises:
determining an average pixel value of the hair part of the intermediate image based on the pixel information of the region where the hair part of the original image is located in the intermediate image; and
determining the target filter information based on the average pixel value and a preset pixel value.
